(19) United States
(12) Patent Application Publication
(10) Pub. No.: US 2009/0244302 A1
(43) Pub. Date: Oct. 1, 2009

(54) CAMERA MODULE WITH IMAGE STABILIZING APPARATUS

(75) Inventor: Shen-Fu TSAI, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/166,282

(22) Filed: Jul. 1, 2008

(30) Foreign Application Priority Data
Mar. 25, 2008 (CN) 200810300700.7

(51) Int. Cl. H04N 5/228

(52) U.S. Cl. 348/208.99

(57) ABSTRACT

A camera module includes a lens module, a box having a through hole for fixing the lens module, an image sensor module, a vibration sensor, a platform assembly, and a controller. The vibration sensor is connected to the image sensor and configured for detecting a vibrating direction and amplitude of the image sensor during capturing and sending signals according to the vibrating direction and amplitude. The platform assembly includes a fixed platform and a movable platform. A side of the movable platform is configured for holding the image sensor module and an opposite side of the movable platform is connected to the fixed platform by a plurality of linear actuators. The linear actuators are configured for moving the movable platform in three rotational directions and in three translational directions. The fixed platform is fixed in the box corresponding to the lens module.

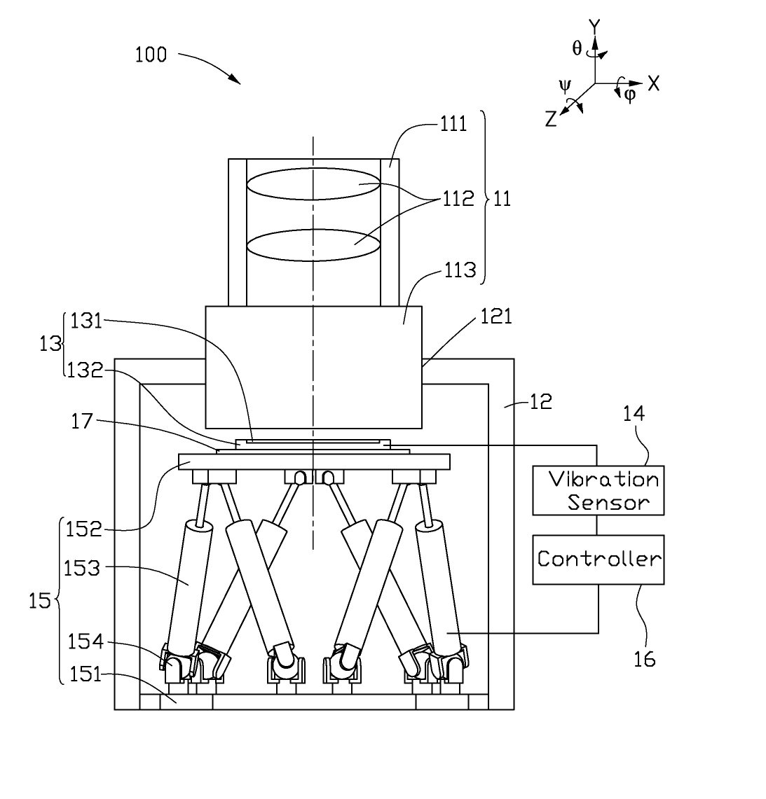

### RELATED FIELD

The present invention generally relates to camera modules, and, in particular, to a camera module with an image stabilizing apparatus.

### BACKGROUND

With the recent advancement of automation of shooting apparatuses such as still cameras and video cameras, size and weight of the apparatus are becoming ever smaller. As a result, recent apparatuses have become small enough and light enough to permit one handed operation by users.

However, during one handed operation of such compact apparatus, such as a video camera having a zoom lens, vibration or shaking of the single hand holding the camera may decrease image quality of the camera.

It is therefore desired to provide a camera module with an image stabilizing apparatus, which can overcome the above-described deficiency.

### SUMMARY

In accordance with exemplary embodiment, a camera module includes, a box having a through hole, a lens module fixed in the through hole of the box, an image sensor module, a vibration sensor, a platform assembly, and a controller. The image sensor module is disposed within the box and at an image side of the lens module. The vibration sensor is connected to the image sensor module and configured for detecting a vibrating direction and amplitude of the image sensor during capturing and sending signals. The platform assembly includes a fixed platform, a movable platform and a plurality of linear actuators. The movable platform is configured for holding the image sensor module. The linear actuators are configured for moving the movable platform in three rotational directions and in three translational directions. The fixed platform is fixed in the box. The controller is in signal communication with the vibration sensor and the linear actuators, and is configured for controlling movement of the movable platform corresponding to the signals from the vibration sensor.

Other novel features and advantages will become more apparent from the following detailed description when taken in conjunction with the accompanying drawings.

### BRIEF DESCRIPTION OF THE DRAWINGS

The present invention is described in detail hereinafter, by way of example and description of an exemplary embodiments thereof and with reference to the accompanying drawing, in which:

The drawing is an schematic view of a camera module having an image stabilizing apparatus according to an exemplary embodiment of the present embodiment.

### DETAILED DESCRIPTION OF THE EXEMPLARY EMBODIMENTS

A detailed explanation of a camera module having an image stabilizing apparatus according to an exemplary embodiment of the present invention will now be made with reference to the drawing attached hereto.

Referring to the drawing, a camera module 100 according to the exemplary embodiment is shown. The camera module 100 includes a lens module 11, a box 12, an image sensor module 13, a vibration sensor 14, a platform assembly 15, and a controller 16.

The lens module 11 is configured for focusing an image of an object (not shown) and includes a barrel 111, a lens group 112 received in the barrel 111, and a holder 113 connected to the barrel 111.

The box 12 is configured for supporting the lens module 11 and containing the image sensor module 13 and the platform assembly 15. The box 12 has a through hole 121 for inserting the holder 113 of the lens module 11 therethrough and thereby fixing the lens module 11 on the box 12.

The image sensor module 13 is disposed at the image side of the lens module 11 and includes an image sensor 131 and a base 132 configured for supporting the image sensor 131. The base 132 is electrically connected to the image sensor 131. The image sensor 131 may be a charge coupled device image sensor or a complementary metal-oxide semiconductor image sensor. In the present embodiment, the image sensor 131 is a charge coupled device image sensor. The image sensor module 13 is configured for capturing images and converting the images into digital data to be processed by a processor (not shown).

The vibration sensor 14, which may be an angular velocity sensor, an acceleration sensor or the like, is connected to the image sensor module 13 and configured for detecting a direction and amplitude of the image sensor module 13 caused by vibration (such as from a shaking hand of a user) during image capture and sending of signals to the controller 16.

The platform assembly 15 is able to move the image sensor module 13 in six degrees of freedom, namely three translational degrees of freedom (X, Y, Z) and three rotational degrees of freedom (θ, φ, χ). The degrees of freedom can be according to conventional definitions wherein the X-axis and Y-axis are orthogonal and co-planar, and the Z-axis is contained in a plane orthogonal to the plane of the X-axis and Y-axis. As is also conventional, θ can be an angular rotation about the Z-axis, φ can be an angular rotation about the Y-axis, and χ can be an angular rotation about the X-axis. The three rotational degrees of freedom are also sometimes referred to as pitch, yaw and roll.

In order to allow movement, in six degrees of freedom, with high precision, the platform assembly 15 includes a hexapod, or Stewart platform. The platform assembly 15 includes a fixed platform 151 and a movable platform 152. The movable platform 152 is connected to the fixed platform 151 by a number of linear actuators 153. In the present embodiment, six linear actuators 153 are presented as an example to explain configurations and working principles of the platform assembly 15. The linear actuators 153 are preferably connected to the fixed platform 151 and to the movable platform 152 by universal (ball) joints 154 at each end thereof. While universal ball joints 154 are preferred, other connection mechanism allowing sufficient freedom of movement could be utilized without departing from the spirit and scope of the present invention. The image sensor module 13 is fixed on the movable platform 152 opposite to the fixed platform 151. It is appreciated that the platform assembly 15 includes a holding mechanism (not shown) disposed on the movable platform 152 for holding the image sensor module 13. Understandably, the fixed platform 151 can be a portion of the box 12 or an independent element connected to the box 12 by any conventional method, such as screwing, welding, and the like. In the present embodiment, the fixed platform 151 is an independent element within the box 12.

The controller 16 is electronically connected between the vibration sensor 14 and the platform assembly 15. The controller 16, which drives the linear actuators 153 of the platform assembly 15, is in signal communication with the vibration sensor 14 which generates electronic signals. The controller 16 controls the linear actuators 153 and can be a computer, or a central processing unit (CPU) possessing sufficient computing power to precisely control the six linear actuators 153 to rotate, extend or shorten according to signals from the vibration sensor 14.

The camera module further includes a printed circuit board (PCB) 17 disposed between the image sensor module 13 and the movable platform 152. The PCB is electronically connected to the image sensor module 13 and configured for transmitting signals generated by the image sensor module 13 to other devices, such as processors.

As described above, unwanted movement of the lens module 11 or the image sensor module 13 due to vibration may be compensated for utilizing the vibration sensor 14 and the platform assembly 15. Therefore, image quality may be enhanced

It should be understood that the above-described embodiment is intended to illustrate rather than limit the invention. Variations may be made to the embodiments without departing from the spirit of the invention. Accordingly, it is appropriate that the appended claims be construed broadly and in a manner consistent with the scope of the invention.

What is claimed is:

1. A camera module with an image stabilizing apparatus, comprising:
a box having a through hole;
a lens module fixed in the through hole of the box and configured for imaging an object;
an image sensor module disposed within the box and at an image side of the lens module;
a vibration sensor connected to the image sensor module and configured for detecting a vibrating direction and amplitude of the image sensor module, during capturing and sending signals according to the vibrating direction and amplitude;
a platform assembly comprising a fixed platform and a movable platform and a plurality of linear actuators connecting to the fixed platform and the movable platform, the movable platform being configured for holding the image sensor module, the linear actuators being configured for moving the movable platform in three rotational directions and in three translational directions, the fixed platform being fixed in the box; and
a controller in signal communication with the vibration sensor and a linear actuators, the controller being configured for controlling movement of the movable platform corresponding to the signals from the vibration sensor.

2. The camera module as claimed in claim 1, wherein the image sensor is a charge coupled device image sensor.

3. The camera module as claimed in claim 1, wherein the image sensor is a complementary metal-oxide semiconductor image sensor.

4. The camera module as claimed in claim 1, wherein the plurality of linear actuators are a hexapod.

5. The camera module as claimed in claim 1, wherein the controller comprises a computer.

6. The camera module as claimed in claim 1, wherein the controller comprises a CPU.

7. The camera module as claimed in claim 1, wherein the platform assembly further comprises a holding mechanism on the movable platform for holding the image sensor module.

8. The camera module as claimed in claim 1, wherein the translational directions are along an X axis, a Y axis, and a Z axis.

9. The camera module as claimed in claim 1, wherein the rotational directions are about an X axis, a Y axis, and a Z axis.

10. The camera module as claimed in claim 1, wherein the vibration sensor is an angular velocity sensor.

11. The camera module as claimed in claim 1, wherein the vibration sensor is an acceleration sensor.
